(19) United States
(12) Patent Application Publication
(10) Pub. No.: US 2005/0034323 A1
(43) Pub. Date: Feb. 17, 2005

(54) Noncontact web transporting method and apparatus

(76) Inventor: Yasuhiko Naruoka, Shizuoka (JP)

Correspondence Address: BIRCH STEWART KOLASCH & BIRCH, PO BOX 747, FALLS CHURCH, VA, 22040-0747, US

(21) Appl. No.: 10/899,176

(22) Filed: Jul. 27, 2004

(30) Foreign Application Priority Data
Jul. 28, 2003 (JP) 2003-281355

(51) Int. Cl. F26B 11/02

(52) U.S. Cl. 34/618

(57) ABSTRACT

The inside of a turn bar is divided into three equal chambers by partitions. A flow of air is intercepted among the divided three chambers. Each chamber is provided with an air duct through which the air flows into the chamber from a blower. An inner pressure of each chamber is adjusted in accordance with the air flowing into the chamber. The inner pressure of the middle chamber is set so as to be higher than the inner pressures of the other chambers. Since the inner pressures of the respective chambers are higher than an outer pressure thereof, the air is jetted from air jet openings formed in a transporting surface of the turn bar.

### BACKGROUND OF THE INVENTION

1. Field of the Invention

The present invention relates to a method and an apparatus for transporting a web in a noncontact manner and in a stable levitated state.

2. Description of the Related Art

A web of aluminum and so forth is transported by rollers at a line for producing a photosensitive printing plate (PS plate). At this time, contact between the web and the roller is likely to damage a web surface, and a quality defect is likely to be caused. In consideration of this, it is preferable that a number of the rollers to be disposed for processes is reduced to the utmost at the line. In the best method, the web is transported without keeping the web surface in a contact state. With respect to a noncontact transporting method, there is a method utilizing an air cushion, for example. A transporting apparatus adopting the air-cushion method is required to have compactness as the alternative to the roller transport. In view of this, a compact air-cushion apparatus is proposed (see Japanese Patent Laid-Open Publication No. 2000-16649, for instance). In this air-cushion apparatus, a turn bar for levitating a web is adapted to have a similar size to a roller having a diameter of 300 mm, by combining a high-pressure air outflow and a low opening ratio of 1% or less. Such an air-cushion apparatus is put on the market.

However, when the turn bar described in the above-noted Publication No. 2000-16649 is used to levitate the aluminum web by 11.0 mm on condition that tension is 1000N, necessary inner pressures thereof are greatly different regarding two cases, in one of which the aluminum web having a width of 400 mm is levitated and in the other of which the aluminum web having a width of 1500 mm is levitated. When the aluminum web of the 1500 mm width is levitated, it is sufficient that the inner pressure of the turn bar is half of the case in that the aluminum web of the 400 mm width is levitated. Thus, it is difficult to effectively and stably levitate the aluminum webs, of which the widths are 400 mm to 1650 mm, by using the above-mentioned turn bar.

Moreover, when a blower is selected for adequately levitating a reader of the 400 mm-width aluminum web, the blower to be selected has excessive performance relative to the web having the broad width. Thus, there arises a problem in that running cost increases.

### SUMMARY OF THE INVENTION

In view of the foregoing, it is a primary object of the present invention to provide a noncontact web transporting method in which webs having different widths are efficiently transported in a stable levitated state.

It is a second object of the present invention to provide a noncontact web transporting apparatus in which webs having different widths are efficiently transported in a stable levitated state.

In order to achieve the above and other objects, the noncontact web transporting method according to the present invention comprises a step of levitating the web by fluid, which is jetted from discharge openings formed in a transporting surface of a turn bar. The inside of the turn bar is divided into plural chambers arranged in a direction perpendicular to a transporting direction of the web. Inner pressures of the chambers are set so as to be increasingly heightened from the end chamber toward the central chamber.

The noncontact web transporting apparatus according to the present invention comprises a turn bar for levitating the web by fluid, which is jetted from discharge openings formed in a transporting surface of the turn bar. The inside of the turn bar is divided into several regions to form a plurality of chambers arranged in a width direction of said transporting surface. The chambers are set such that inner pressures thereof are increasingly heightened from the end chamber toward the central chamber.

The inner pressure of the respective chambers is adjusted by controlling a blowing member in accordance with a width of the web.

In a preferred embodiment, a number of the chambers is three. The blowing members are individually provided for the central chamber and the end chambers.

In another embodiment, the discharge openings are arranged such that an opening ratio thereof to the transporting surface is greater at a central portion rather than an end portion in the width direction of the transporting surface.

According to the noncontact web transporting method and apparatus of the present invention, it is possible to transport the webs having different widths in a stable levitated state. When the turn bar is divided into the chambers and the inner pressures thereof are adjusted by the blowing members, it is possible to select proper blowers relative to the webs having different sizes. Thus, running cost may be decreased.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a process for producing a photosensitive printing plate according to the present invention;

FIG. 2 is a schematic illustration showing a structure of a noncontact web transporting apparatus of the present invention;

FIG. 3 is a perspective view showing a structure of a turn bar;

FIG. 4 is an explanatory illustration showing an operation of the noncontact web transporting apparatus;

FIG. 5 is an explanatory illustration showing an operation of the noncontact web transporting apparatus;

FIG. 6 is an explanatory illustration showing another embodiment of the noncontact web transporting apparatus: and

FIG. 7 is a perspective view showing a structure of another turn bar.

### DETAILED DESCRIPTION OF THE PREFERRED EMBODIMENT(S)

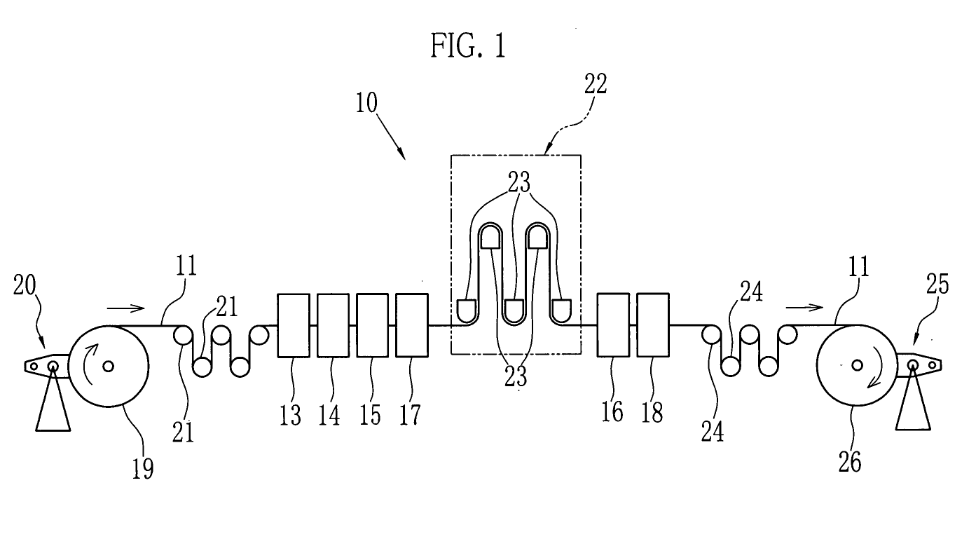

A first embodiment of the present invention is described bellow, referring to the drawings. FIG. 1 is a schematic illustration showing PS-plate producing machinery according to the present invention. The PS-plate producing machinery 10 includes a surface treating unit 13, a water washing unit 14, first and second coating units 15 and 16, and first and second drying units 17 and 18. A web 11 made of aluminum is advanced from a web roll 19 by means of a web feeding device 20, and is forwarded to the surface treating unit 13 by a plurality of rollers 21. The surface treating unit 13 treats a surface of the web 11 in order to improve applicability and adhesivity of a photosensitive compound to be applied to the surface of the web 11. The surface-treated web 11 is cleaned in the water washing unit 14 and is successively coated with a photosensitive coating liquid by the first coating unit 15.

The web 11 coated by the first coating unit 15 is forwarded to the first drying unit 17 to dry the coated surface. For transporting the web 11 from the first drying unit 17 to the second coating unit 16, a noncontact web transporting apparatus 22 of the first embodiment is used. A plurality of turn bars 23 are employed as transporting members. The turn bar 23 levitates the web 11 to transport it in a noncontact manner. In virtue of this, the coated surface, which has high adhesivity even after drying this surface, is managed without contacting any member up to the second coating unit 16. A coating liquid for a protect layer is applied in the second coating unit 16. Successively, the web 11 is dried in the second drying unit 18. The dried web 11 is transported by a plurality of rollers 24. After that, the web 11 is taken up around a core 26 by means of a web taking-up device 25. By the way, the present invention is not exclusive to the system shown in FIG. 1.

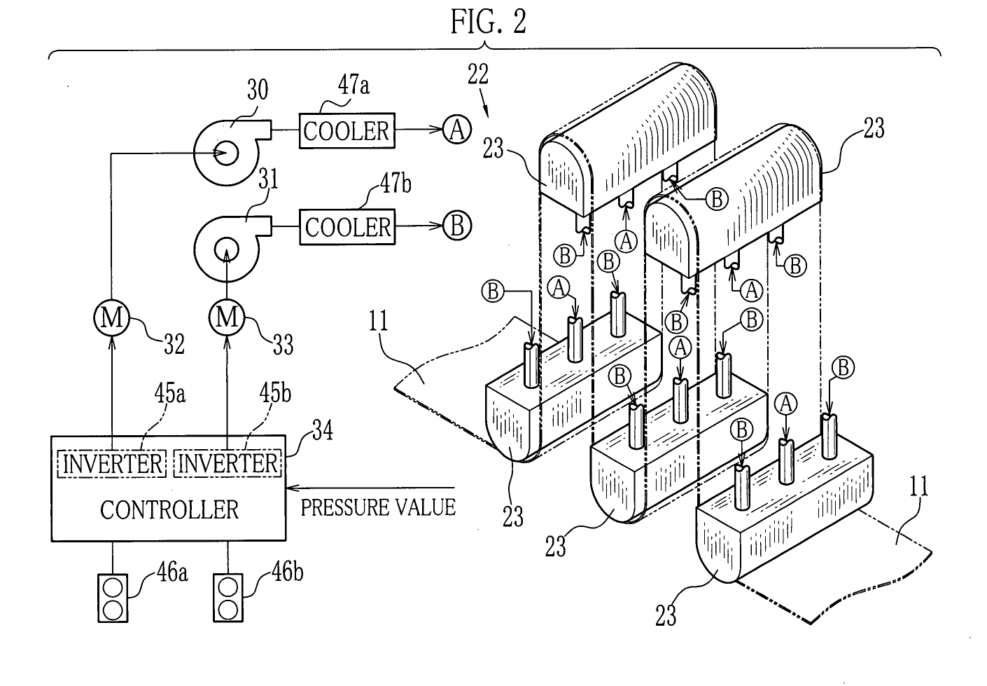

FIG. 2 is a schematic illustration showing a structure of the noncontact web transporting apparatus 22 of the first embodiment. This apparatus 22 comprises five turn bars 23, two blowers 30 and 31 for supplying the air to the turn bars 23, motors 32 and 33 for driving the blowers 30 and 31, and a controller 34 for controlling the motors 32 and 33.

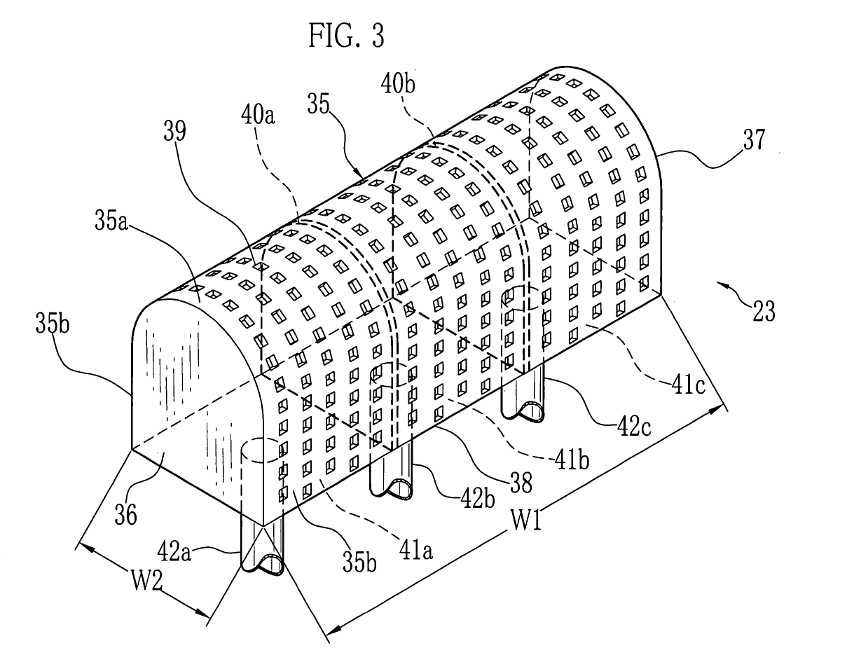

FIG. 3 is a perspective view showing a structure of the turn bar 23 comprising a U-shaped transporting surface 35, two side walls 36 and 37, and a bottom plate 38. The transporting surface 35 constitutes three sides of the turn bar 23, namely a front side, a rear side and an upper side. The side walls 36 and 37 constitute lateral sides of the turn bar 23 and cover both ends of the transporting surface 35. The bottom plate 38 constitutes the under side of the turn bar 23 and covers the bottom of the transporting surface 35.

The transporting surface 35 comprises a curved area 35a bent in an arc shape, and plane areas 35b extending from both edges of the curved area 35a in a transporting direction. The transporting surface 35 is a jet surface for jetting out the air to levitate and transport the web 11. All over the curved area 35a and the plane areas 35b, air jet openings 39 having a same size are formed at predetermine intervals in a staggered state. In this embodiment, the longitudinal interval of the air jet openings 39 is 10.0 mm and the lateral interval thereof is 10.5 mm. The present invention, however, is indifferent about the shape of the air jet openings 39 and the intervals thereof. Incidentally, as to the air jet openings 39 shown in the drawing, the size and the intervals thereof are magniloquently illustrated for the purpose of avoiding complication.

The inside of the turn bar 23 is divided into three chambers 41a, 41b and 41c by two partitions 40a and 40b evenly spaced. Airflow is interrupted between the respective chambers. The bottom plate 38 is formed with air ducts 42a, 42b and 42c for supplying the air to the respective chambers 41a to 41c divided into three. The air supplied from the air ducts 42a to 42c is jetted out of the air jet openings 39 to levitate the web 11 so that the web 11 is transported by the turn bar 23 in a noncontact manner.

Meanwhile, the controller 34 includes inverters 45a and 45b being as frequency converters. Moreover, the controller 34 is connected to operation members 46a and 46b to be operated by an operator. The controller 34 controls the inverters 45a and 45b on the basis of the operation, which is performed with the operation members 46a and 46b, to change a frequency of a voltage to be applied to the motors 32 and 33 so that revolutions of the motors 32 and 33 are changed. In virtue of this, it is possible to properly change air amounts of the blowers 30 and 31. Thus, it is possible to finely control inner pressures of the respective chambers 41a to 41c. The controller 34 may obtain pressure values of the chambers 41a to 41c by providing pressure sensors (not shown) in the respective chambers 41 to 41c. In this case, the controller 34 obtains measured values from the pressure sensors so that it is possible to more finely control the inner pressures of the respective chambers 41a to 41c.

Coolers 47a and 47b are connected to the blowers 30 and 31 respectively. The air discharged from the respective blowers 30 and 31 is cooled by the coolers 47a and 47b. The cooled air is supplied to the respective three chambers 41a to 41c through the air ducts 42a to 42c. Preset cooling temperatures of the coolers 47a and 47b are determined so as to satisfy a condition that a temperature of the web 11 is lowered to an adequate temperature in the second coating unit 16.

In this embodiment, a width W1 of the air jet surface is 1800 mm, and a width W2 of the turn bar 23 is 600 mm. These sizes, however, may be properly changed in accordance with a size of the transported one. Moreover, the arrangement position of the turn bars 23 is not exclusive to this embodiment.

The air jet opening 39 formed in the air jet surface is an orifice of a break, which is caused when a protrusion of the air jet surface is formed toward a rear side thereof. This orifice becomes the discharge opening for the air. Although the discharge opening is formed by a press, it is possible to adopt various well-known processing methods for properly forming the opening.

In this embodiment, a ratio of the openings to the air jet surface is 0.55%. However, this is not exclusive. The ratio of the openings may be 0.25% or more and 5.0% or less. Incidentally, the ratio of the openings is calculated such that a total area of the openings divided by an area of the transporting surface is multiplied by 100.

Next, it is described below to supply the air to the turn bar 23. The controller 34 drives and controls the motors 32 and 33 to discharge the air from the blowers 30 and 31. The air discharged from the respective blowers 30 and 31 passes through the respective coolers 47a and 47b, and then, the cooled air flows into the chambers 41a, 41b and 41c through the air ducts 42a, 42b and 42c. The blower 30 is connected to the air duct 42b so that the air discharged from the blower 30 flows into the chamber 41b through the air duct 42b. The other blower 31 is connected to the air ducts 42a and 42c so that the air discharged from the blower 31 flows into the chambers 41a and 41c through the air ducts 42a and 42c.

Capacities of the blowers 30 and 31 are determined such that an air amount flowing from the blower 30 into the chamber 41b is greater than an air amount flowing from the blower 31 into the respective chambers 41a and 41c. Thus, the inner pressure of the chamber 41b is higher than that of the respective chambers 41a and 41c. In accordance with a system structure, the blowers having proper capacities are selected so as to make the inner pressure of the chamber 41b higher that that of the respective chambers 41a and 41c.

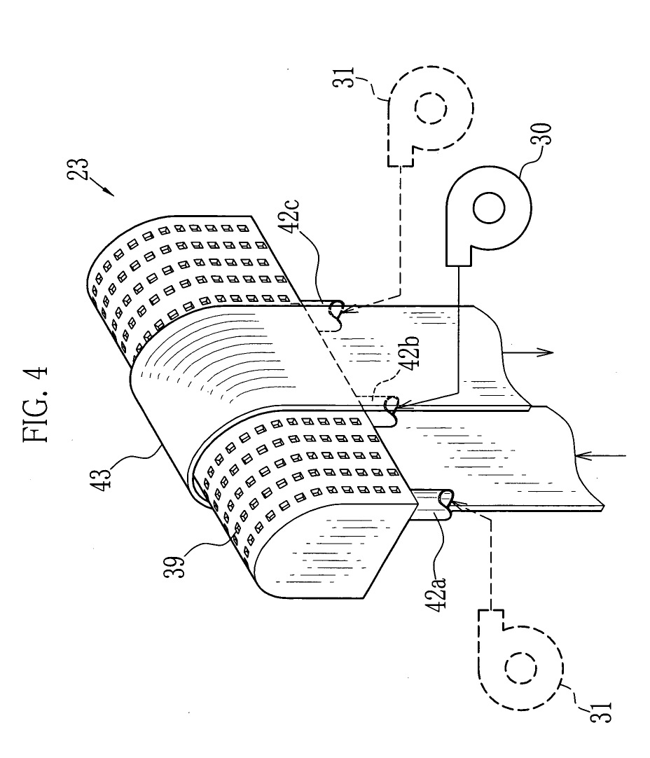

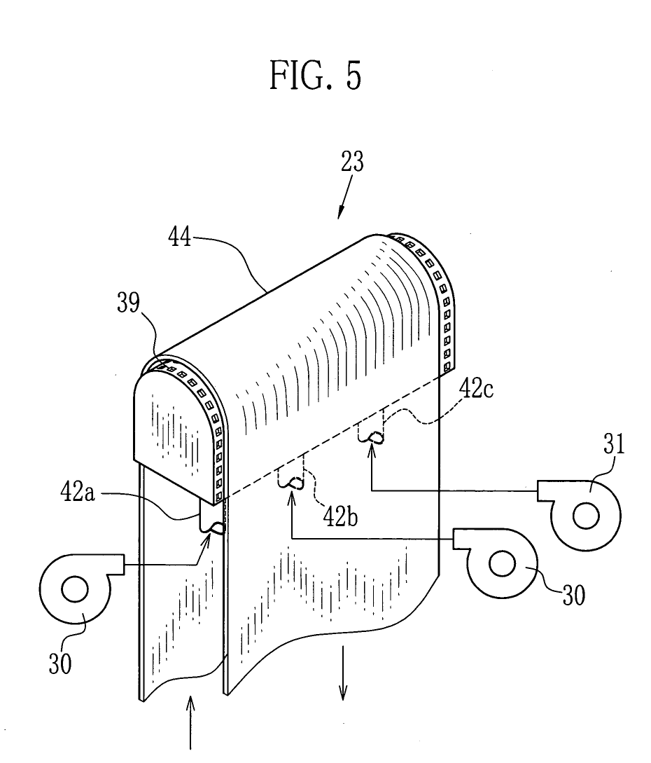

Next, an operation of the noncontact web transporting apparatus 22 having the above structure is described below regarding two cases, referring to FIGS. 4 and 5. In one of the cases, a reader and the web having a narrow width are transported. In the other of the cases, the web having a wide width is transported. When a narrow web 43, whose width is 400 mm for example, is transported such as shown in FIG. 4, the controller 34 drives the motor 32 so that the air discharged from the blower 30 flows into the chamber 41b through the air duct 42b. Since the air flows into the chamber 41b, an air pressure therein raises. Consequently, the inner pressure of the chamber 41b becomes higher than the outer pressure of the turn bar 23. Thus, the air is jetted from the air jet openings 39 formed in the periphery of the chamber 41b. At this time, the inner pressure of the chamber 41b is 30 kpa or more. This inner pressure, however, is changed in accordance with kinds of the transported webs and the capacities of the used blowers.

Meanwhile, since the controller 34 does not drive the motor 33, the air is not discharged from the blower 31. Consequently, the air pressures in the chambers 41a and 41c do not rise. Thus, the air is not jetted from the air jet openings 39 formed in the peripheries of the chambers 41a and 41c.

Regarding each of the five turn bars 23, the air is jetted from the air jet openings 39 formed in the periphery of the chamber 41b such as described above. The web 43 is levitated by the turn bars 23 and is transported in the noncontact manner.

In the meantime, is described below the case in that the wide web is transported. When the wide web 44, whose width is 1500 mm for example, is transported in the noncontact manner, the controller 34 drives both the motors 32 and 33 such as shown in FIG. 5. Thereupon, the air discharged from the respective blowers 30 and 31 flows into the respective chambers 41a, 41b and 41c through the air ducts 42a, 42b and 42c. Since the air flows into the chambers 41a, 41b and 41c, the air pressures therein raise. Consequently, the inner pressures of the chambers 41a, 41b and 41c become higher than the outer pressure of the turn bar 23. Thus, the air is jetted from all over the air jet surface. At this time, the inner pressures of the chambers 41a and 41c are about 15 kpa, and the inner pressure of the chamber 41b is 30 kpa or more. The inner pressures, however, are changed in accordance with kinds of the transported webs and the capacities of the used blowers.

Regarding each of the five turn bars 23, the air is jetted from the air jet openings 39 of the whole air jet surface such as described above. The web 44 is levitated by the turn bars 23 and is transported in the noncontact manner.

As described above, the inner pressure of the middle chamber 41b of the turn bar 23 is set to the higher pressure as need arises for transporting the narrow aluminum web and the reader. The inner pressures of the other chambers 41a and 41c are lowered in accordance with the width of the web. It is possible to select the appropriate blowers relative to the webs having different width sizes. Thus, the running cost may be decreased.

By operating the operation members 46a and 46b to change revolutions of the blowers 30 and 31, the air blow is finely controlled to obtain a proper air pressure and a proper air amount. The air obtained in this way is supplied to the turn bar 23. In virtue of this, the aluminum web, which has a thickness of 0.1 to 0.5 mm and a width of 400 to 1650 mm, can be energy-efficiently transported in the noncontact manner with a tension of 1000N or more.

The blower 30 is provided for the middle chamber 41b and the blower 31 is used for the wide web. It is possible to halt the blower 31 to be used for the wide web while the narrow aluminum web or the reader is transported or while the line is stopped. Consequently, the running cost is decreased. Meanwhile, the air flowing into the respective chambers 41a, 41b and 41c is cooled so that the air is prevented from becoming high temperature due to a boost in the air pressure.

As for the above noncontact web transporting apparatus 22, in order to heighten the inner pressure of the middle portion of the turn bar 23 rather than the inner pressures of both sides thereof, the double blowers 30 and 31 are provided to have distribution relative to the inner pressure of the turn bar 23. However, this is not exclusive. The noncontact web transporting apparatus may employ a single blower. Hereinafter, is described another embodiment in that the noncontact web transporting apparatus employs the sole blower.

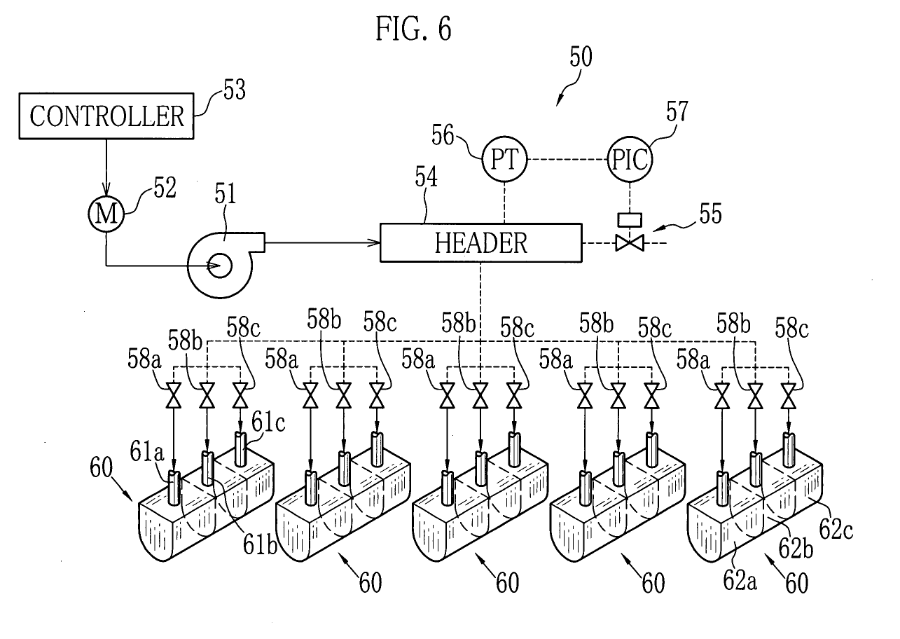

FIG. 6 is a schematic illustration showing a structure of a noncontact web transporting apparatus 50 according to a second embodiment. This apparatus 50 comprises a blower 51, a motor 52 for driving the blower 51, a controller 53 for controlling the motor 52, a header 54 being as a pressure tank, a control valve 55 for adjusting an inner pressure of the header 54, a PT 56 for measuring the inner pressure of the header 54, a pressure adjuster 57 for controlling the control valve 55, and five turn bars 60. The pressure adjuster 57 obtains a pressure value from the PT 56 and controls opening and closing of the control valve 55 to set a predetermined pressure value.

The turn bar 60 has an identical structure with the turn bar 23 of the noncontact web transporting apparatus 22, and detailed description thereof is abbreviated. The turn bar 60 is provided with air ducts 61a, 61b and 61c similarly to the turn bar 23. The air ducts 61a, 61b and 61c are connected to the header 54 via pressure reducing valves 58a, 58b and 58c. Incidentally, the five turn bars 60 are disposed at the positions shown in FIG. 2, similarly to the noncontact web transporting apparatus 22.

In addition, similarly to the noncontact web transporting apparatus 22, the blower 51 is connected to the controller 53 via the motor 52 for driving the blower 51. The controller 53 drives and controls the motor 52. Upon this, the air flows from the blower 51 into the header 54 and the inner pressure of the header 54 rises. The pressure adjuster 57 obtains the pressure value from the PT 56 and controls opening and closing of the control valve 55 to set the inner pressure of the header 54 to the predetermined pressure value. In this way, the inside of the header 54 is kept at the predetermined pressure.

With respect to the pressure reducing valves 58a, 58b and 58c, depressurization rates of the side valves 58a and 58c are set so as to be greater than that of the middle valve 58b. Thus, inner pressures of chambers 62a and 62c are lower than that of a chamber 62b so that the inner pressure of the turn bar 60 has distribution.

As described above, the middle chamber 62b of the turn bar 60 has higher inner pressure, which is set so as to be enough for transporting the narrow web and the reader. By lowering the inner pressures of the other chambers 62a and 62c in accordance with the width of the web, it is possible to obtain an operation similar to the first embodiment. Noncontact transporting is efficiently performed in the optimum levitated state.

Meanwhile, the controller 53 may be provided with an inverter similarly to the noncontact web transporting apparatus 22 of the first embodiment. In this case, by changing revolutions of the blower 51, the air blow is finely controlled to obtain a proper air pressure and a proper air amount. The air obtained in this way is supplied to the turn bar 60. In virtue of this, the aluminum web, which has a thickness of 0.1 to 0.5 mm and a width of 400 to 1650 mm, can be energy-efficiently transported in the noncontact manner with a tension of 1000N or more.

Similarly to the first embodiment, a cooler may be disposed in front of the blower 51. In this case, an air temperature of the header 54 is prevented from rising.

In the above embodiments, the turn bars 23 and 60 are respectively divided into three chambers. However, this is not exclusive. The turn bar may be divided into more many chambers. By adjusting an inner pressure of each chamber, it is possible to transport the webs of different widths in the noncontact manner, maintaining a more stable levitated state. Incidentally, the turn bar may be divided into plural chambers at irregular intervals.

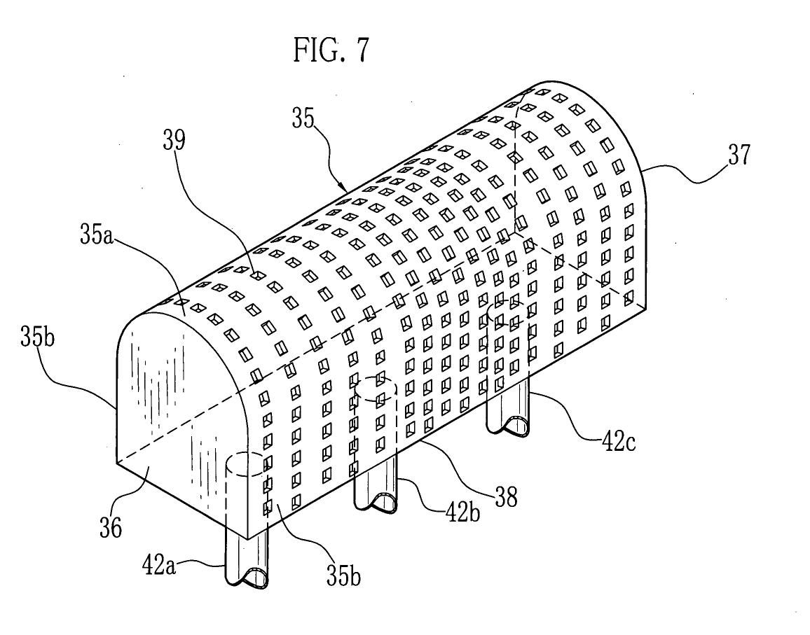

In the above embodiments, the levitation amount of the web is adjusted in the state that the inner pressure of the turn bar has the distribution. However, this is not exclusive. It is possible to utilize a phenomenon that the levitation amount of the web depends on a flow of the air to be discharged in a web-levitating direction. An opening ratio of the turn bar may have distribution in the width direction of the air jet surface thereof. In this case, the opening ratio is higher at a central portion of the turn bar, which corresponds to a leader transporting portion, and the opening ratio becomes smaller toward the ends of the turn bar (edge portions of the web), such as shown in FIG. 7. Similarly to the case that the turn bar is divided, noncontact transporting may be efficiently performed in the optimum levitated state.

In the present invention, it is preferable that a thickness of the web 11 is 0.1 mm or more and 0.5 mm or less. In addition, it is preferable that the tension for the web 11 is 500N or more and 2000N or less in the web-transporting direction. It is most preferable that the tension is 500N or more and 1500N or less. At this time, it is preferable to adjust the tension by drive members, which are disposed at front-and-rear sides of the turn bars 23 and 60, and the inner pressures of the turn bars 23 and 60. Moreover, it is preferable that a transporting speed is lm/min. or more and 200 m/min. or less.

In the forgoing embodiment, the web 11 is transported between the first coating unit 15 and the second coating unit 16. Further, the web 11 is cooled so as to satisfy the condition that the temperature of the web 11 becomes the adequate temperature in the second coating unit 16. The present invention, however, may be adopted to web transporting to be performed in various apparatuses of a drying apparatus, a coating apparatus and so forth.

In the above embodiments, the PS plate is transported in the noncontact manner. However, this is not exclusive. The present invention is applicable to continuous strip-like materials having flexibility, for example, a substrate for a photo film, a baryta paper for a photographic paper, a substrate for a recording tape, a substrate for a video tape, a substrate for a floppy (registered trademark) disk, and so forth.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A noncontact web transporting method for levitating and transporting a web, said method comprising the steps of:
sending a fluid into a plurality of chambers of a turn bar, said chambers being formed by dividing the inside of said turn bar in a direction perpendicular to a transporting direction of said web;
heightening inner pressures of said chambers from the end chambers toward the central chamber; and
jetting said fluid from a plurality of discharge openings formed in a transporting surface of said turn bar to levitate said web from said transporting surface.

2. A noncontact web transporting method according to claim 1, wherein said fluid is sent from at least one blower through a duct connected to each of said chambers.

3. A noncontact web transporting method according to claim 2, wherein a number of said chambers is three, and said fluid is sent from the different blowers relative to the central chamber and both of the end chambers.

4. A noncontact web transporting method according to claim 2, wherein said fluid is sent from the sole blower to each of said chambers via a pressure reducing valve connected to said duct.

5. A noncontact web transporting method according to claim 1, wherein said discharge openings are arranged in a staggered state.

6. A noncontact web transporting apparatus for levitating and transporting a web, said apparatus comprising:
a turn bar for jetting a fluid to levitate said web, said fluid being jetted from discharge openings formed in a transporting surface of said turn bar, and the inside of said turn bar being divided into plural chambers in a width direction of said transporting surface; and
at least one blower for sending said fluid into the respective chambers of said turn bar,
wherein inner pressures of said chambers are heightened from the end chambers toward the central chamber.

7. A noncontact web transporting apparatus according to claim 6, wherein said inner pressures of said chambers are adjusted by controlling said blower in accordance with a width of said web.

8. A noncontact web transporting apparatus according to claim 6, wherein a number of said chambers is three, and said blowers are individually provided relative to the central chamber and both of the end chambers.

9. A noncontact web transporting apparatus according to claim 8, further comprising:
a cooler connected to each of said blowers, said cooler cooling said fluid forwarded from said blower to send the cooled fluid into said chamber.

10. A noncontact web transporting apparatus according to claim 9, wherein said chambers are formed by dividing the inside of said turn bar equally among three with partitions.

11. A noncontact web transporting apparatus according to claim 6, further comprising:
a duct connected to each of said chambers, said fluid flowing into the respective chambers through said duct; and
a pressure reducing valve connected to said duct, said fluid forwarded from the sole blower flowing into said chamber via said pressure reducing valve, and said inner pressure of said chamber being adjusted by said pressure reducing valve.

12. A noncontact web transporting apparatus according to claim 11, further comprising:
a pressure tank disposed between said pressure reducing valve and the sole blower, said fluid forwarded from said blower being supplied to said pressure reducing valve via said pressure tank.

13. A noncontact web transporting apparatus according to claim 12, further comprising:
a piesometer for measuring a pressure value of said pressure tank;
a regulating valve for adjusting a pressure of said pressure tank; and
a controller for controlling said regulating valve in accordance with the pressure value outputted from said piesometer, said controller controlling said regulating valve so as to set the pressure of said pressure tank to a predetermined value.

14. A noncontact web transporting apparatus according to claim 6, wherein said discharge openings are arranged in a staggered state.

15. A noncontact web transporting apparatus for levitating and transporting a web, said apparatus comprising:
a turn bar for jetting a fluid to levitate said web, said fluid being jetted from discharge openings formed in a transporting surface of said turn bar, and an opening ratio of said discharge openings to said transporting surface being greater at a central portion by comparison with end portions in a width direction of said transporting surface; and
a blower for sending said fluid into said turn bar.
